(19) United States
(12) Patent Application Publication
(10) Pub. No.: US 2025/0374341 A1
(43) Pub. Date: Dec. 4, 2025

(54) WIRELESS COMMUNICATION TERMINAL, COMMUNICATION METHOD, AND STORAGE MEDIUM

(71) Applicant: JVCKENWOOD Corporation, Yokohama-shi (JP)

(72) Inventor: Reo Hasegawa, Yokohama-shi (JP)

(21) Appl. No.: 19/299,403

(22) Filed: Aug. 14, 2025

Related U.S. Application Data
(63) Continuation of application No. PCT/JP2024/003119, filed on Jan. 31, 2024.

(30) Foreign Application Priority Data
Feb. 24, 2023 (JP) 2023-027179

(51) Int. Cl. H04W 76/10; H04L 5/00; H04W 4/90; H04W 76/30

(52) U.S. Cl. CPC H04W 76/10; H04L 5/0053; H04W 4/90; H04W 76/30

(57) ABSTRACT

A wireless communication terminal includes: a first communication unit that performs first-type wireless communication according to a first wireless communication method; a second communication unit that performs second-type wireless communication according to a second wireless communication method which is different than the first wireless communication method; and a control unit that controls the first communication unit and the second communication unit. In the state in which the communication mode is switched from the normal communication mode to a predetermined communication mode in which the first communication unit performs continuous transmission according to the first wireless communication method, when the second communication unit receives a connection request signal and establishes a communication connection by sending an acknowledgment signal as a permission for establishing a connection, the control unit controls the first communication unit to temporarily stop the continuous transmission performed according to the first wireless communication method.

### CROSS-REFERENCE TO RELATED APPLICATIONS

This application is a Continuation of PCT International Application No. PCT/JP2024/003119 filed on Jan. 31, 2024 which claims the benefit of priority from Japanese Patent Application No. 2023-027179, filed on Feb. 24, 2023, the entire contents of both of which are incorporated herein by reference.

### BACKGROUND OF THE INVENTION

### 1. Field of the Invention

The application concerned relates to a wireless communication terminal, a communication method, and a computer program product.

### 2. Description of the Related Art

A technology is known by which, when a user of a wireless communication terminal faces an emergency situation, that wireless communication terminal switches the communication mode to the emergency mode and automatically sends, to the other wireless communication terminals belonging to the same group, a notification indicating that the user thereof is facing an emergency situation (for example, refer to Japanese Patent Application Laid-open No. 2003-243999).

When a wireless communication terminal switches the communication mode from the normal communication mode to the emergency mode, it automatically sends a notification to other wireless communication terminals in a repeated manner for a predetermined period of time. Such a transmission operation in the emergency mode differs from the normal communication operation in which a predetermined communication method is implemented while using the same communication frequency specified for each communication area. Hence, at the time of performing the normal communication operation in which communication is performed with the other wireless communication terminals belonging to the same group, in case the transmission operation in the emergency mode is carried out, it leads to an increased possibility of causing communication jamming that results in interference and congestion in the normal communication operation.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A wireless communication terminal according to the present disclosure comprising: a first communication unit that performs first-type wireless communication according to a first wireless communication method; a second communication unit that performs second-type wireless communication according to a second wireless communication method which is different than the first wireless communication method; and a control unit that controls the first communication unit and the second communication unit, wherein in a state in which communication mode is switched from a normal communication mode to a predetermined communication mode in which the first communication unit performs continuous transmission according to the first wireless communication method, when the second communication unit receives a connection request signal and establishes a communication connection by sending an acknowledgment signal as a permission for establishing a connection, the control unit controls the first communication unit to temporarily stop continuous transmission performed according to the first wireless communication method.

A communication method according to the present disclosure in which a first communication unit is controlled to perform first-type wireless communication according to a first wireless communication method and a second communication unit is controlled to perform second-type wireless communication according to a second wireless communication method that is different than the first wireless communication method, the communication method comprising: performing control, by a control unit, that includes controlling the first communication unit to switch communication mode from a normal communication mode to a predetermined communication mode in which continuous transmission is performed according to the first wireless communication method; receiving, by the second communication unit, that includes receiving a connection request signal; performing control, by the control unit, that includes controlling the second communication unit to send an acknowledgment signal as a permission for establishing a connection in response to the received connection request signal and to establish a communication connection using the second communication unit; and performing control, by the control unit, that, after establishment of the communication connection, includes controlling the first communication unit to temporarily stop continuous transmission performed according to the first wireless communication method.

A non-transitory computer-readable storage medium according to the present disclosure storing a program causing a computer to execute, having a computer readable medium including a computer program for causing a computer to perform an operation in which a first communication unit is controlled to perform first-type wireless communication according to a first wireless communication method and a second communication unit is controlled to perform second-type wireless communication according to a second wireless communication method that is different than the first wireless communication method, wherein the computer program, when executed by the computer, causes the computer to execute: performing control, by a control unit, that includes controlling the first communication unit to switch communication mode from a normal communication mode to a predetermined communication mode in which continuous transmission is performed according to the first wireless communication method; receiving, by the second communication unit, that includes receiving a connection request signal; performing control, by the control unit, that includes controlling the second communication unit to send an acknowledgment signal as a permission for establishing a connection in response to the received connection request signal and to establish a communication connection using the second communication unit; and
performing control, by the control unit, that, after establishment of the communication connection, includes controlling the first communication unit to temporarily stop continuous transmission performed according to the first wireless communication method.

### BRIEF DESCRIPTION OF THE DRAWINGS

FIG. 1 is a diagram illustrating an exemplary configuration of a wireless communication system according to a first embodiment;

FIG. 2 is a diagram for explaining the overview of the operations performed in wireless communication terminals according to the first embodiment;

FIG. 3 is a block diagram illustrating an exemplary configuration of the wireless communication terminal according to the first embodiment;

FIG. 4 is a sequence diagram illustrating the flow of a communication establishment operation performed to establish communication between the wireless communication terminals according to the first embodiment;

FIG. 5 is a sequence diagram illustrating the flow of a communication establishment restoration operation for restoring the communication between the wireless communication terminals according to the first embodiment;

FIG. 6 is a sequence diagram illustrating the flow of a communication establishment end operation for ending the communication established between the wireless communication terminals according to the first embodiment;

FIG. 7 is a flowchart for explaining the operation details of the wireless communication terminal according to the first embodiment;

FIG. 8 is a flowchart for explaining the operation details of the wireless communication terminal according to a second embodiment;

FIG. 9 is a flowchart for explaining the operation details of the wireless communication terminal according to a third embodiment; and

FIG. 10 is a block diagram illustrating an exemplary configuration of a wireless communication terminal according to a fourth embodiment.

### DETAILED DESCRIPTION OF THE PREFERRED EMBODIMENTS

Exemplary embodiments of the application concerned are described below in detail with reference to the accompanying drawings. However, the application concerned is not limited by the embodiments described below. In the embodiments described below, identical constituent elements are referred to by the same reference numerals, and their explanation is not given in a repeated manner.

### First Embodiment

### Wireless Communication System

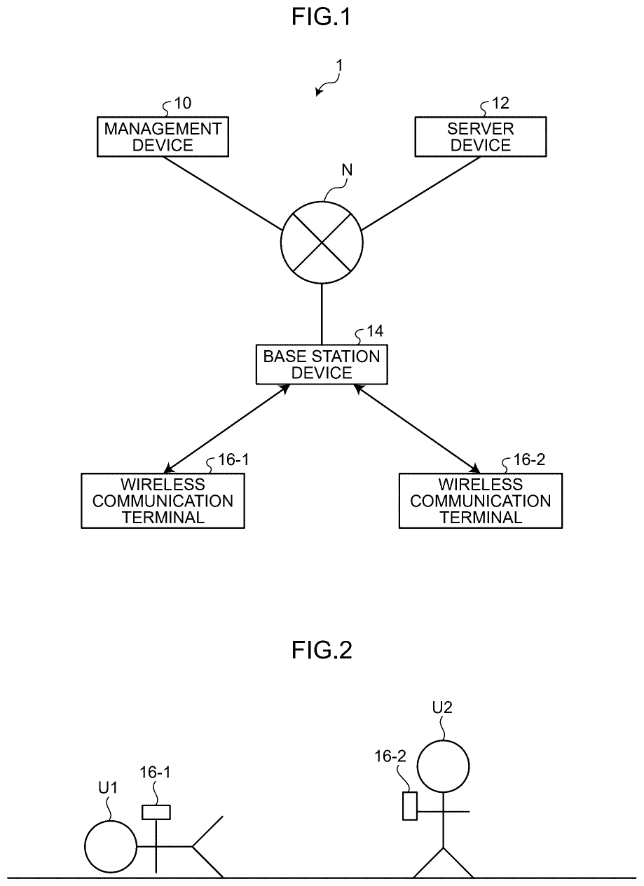

Explained below with reference to FIG. 1 is an exemplary configuration of a wireless communication system according to a first embodiment. FIG. 1 is a diagram illustrating an exemplary configuration of the wireless communication system according to the first embodiment.

As illustrated in FIG. 1, the wireless communication system 1 includes a management device 10, a server device 12, a base station device 14, and wireless communication terminals 16. In the example illustrated in FIG. 1, in the wireless communication system 1, two wireless communication terminals 16-1 and 16-2 are included as the wireless communication terminals 16. However, the application concerned is not limited to that case. Thus, in the application concerned, there is no restriction on the number of wireless communication terminals 16 to be included in the wireless communication system 1.

The management device 10, the server device 12, and the base station device 14 are communicably connected to each other via a network N. Examples of the network N include, but are not limited to, the Internet.

The management device 10 manages the communication performed in the wireless communication system 1. For example, the management device 10 manages the communication performed between the wireless communication terminals 16-1 and 16-2 in the wireless communication system 1. Moreover, for example, the management device 10 manages a variety of application software stored in the wireless communication terminals 16. Furthermore, for example, the management device 10 manages the setting items related to the communication between the wireless communication terminals 16. The management device 10 can be implemented using, for example, a personal computer (PC).

The server device 12 controls the communication performed in the wireless communication system 1. For example, the server device 12 controls the communication performed between the wireless communication terminals 16-1 and 16-2 in the wireless communication system 1. Moreover, for example, the server device 12 controls a variety of application software stored in the wireless communication terminals 16. Furthermore, for example, the server device 12 controls the setting items related to the communication between the wireless communication terminals 16. The server device 12 can be implemented using, for example, a server PC or a cloud server.

The base station device 14 is a wireless communication device that performs wireless communication with the wireless communication terminals 16. For example, the base station device 14 sends a variety of data to and receives a variety of data from the wireless communication terminals 16. For example, the base station device 14 is a wireless communication device compatible to a commercial wireless base station, or compatible to 3G (third generation mobile communication system), or compatible to 4G (fourth generation mobile communication system), or compatible to 5G (fifth generation mobile communication system).

Each wireless communication terminal 16 is a terminal device used by a user in the wireless communication system 1. Each user in the wireless communication system 1 can use the wireless communication terminal 16 to talk with another user who is carrying another wireless communication terminal 16. Each wireless communication terminal 16 has a function by which, when the corresponding user faces an emergency situation that requires help, the communication mode is switched from the normal communication mode to a predetermined communication mode and a notification is sent indicating that the user is facing an emergency situation. Herein, it serves the purpose if the predetermined communication mode is the emergency mode in which a notification about an emergency situation is automatically sent without involving a PTT operation. Alternatively, the predetermined communication mode can be a communication mode in which only alarm-less emergency transmission is automatically performed without involving a PTT operation. The normal communication mode represents the operation mode in which normal communication such as talking is performed. The emergency mode represents the operation mode in which a notification is sent indicating that the user is facing an emergency situation. In the emergency mode, it serves the purpose if the fact that the user is facing an emergency situation is notified along with predetermined emergency information. Regarding the operations in the emergency mode and regarding the predetermined emergency information, the detailed explanation is given later. After the communication mode has been switched to the emergency mode, when predetermined conditions are satisfied, the wireless communication terminal 16 switches the communication mode back to the normal communication mode. The wireless communication terminal 16 can be configured either using a single device or using a plurality of devices. Regarding the configuration of the wireless communication terminal 16, the explanation is given later.

### Overview of Operations Performed in Wireless Communication Terminals

Explained below with reference to FIG. 2 is the overview of the operations performed in the wireless communication terminals according to the first embodiment. FIG. 2 is a diagram for explaining the overview of the operations performed in the wireless communication terminals according to the first embodiment.

In FIG. 2, users U1 and U2 are illustrated. The user U1 is assumed to use the wireless communication terminal 16-1, and the user U2 is assumed to use the wireless communication terminal 16-2. When the wireless communication terminal 16-1 detects that the user U1 has collapsed, it switches the communication mode to the emergency mode. After switching the communication mode to the emergency mode, the wireless communication terminal 16-1 causes an alarm to go off; performs an emergency operation in which continuous transmission according to a first wireless communication method, that is, a wireless transmission operation and a standby operation is performed in a repeated manner; and starts a standby operation according to a second wireless communication method. Herein, in the continuous transmission, a wireless transmission operation can be continuously performed based on automatic transmission and without involving a PTT operation. Alternatively, in the continuous transmission, a wireless transmission operation can be intermittently performed based on automatic transmission and without involving a PTT operation. When the wireless communication terminal 16-2 receives wireless signals from the wireless communication terminal 16-1, the user U2 heads off to help out to the user U1. Herein, while the wireless communication terminal 16-1 is performing the emergency operation, there may arise a situation in which the channel remains occupied and the other users become unable to use the radio waves. In that case, the user U2 becomes unable to use the wireless communication terminal 16-2 and talk with other users who have headed off to help the user U1, thereby possibly posing a problem as far as helping out the user U1 is concerned. In that regard, in the first embodiment, when predetermined conditions are satisfied, the wireless communication terminal 16-1 temporarily stops the wireless transmission operation according to the first wireless communication operation and prevents the channel from remaining occupied.

### Wireless Communication Terminal

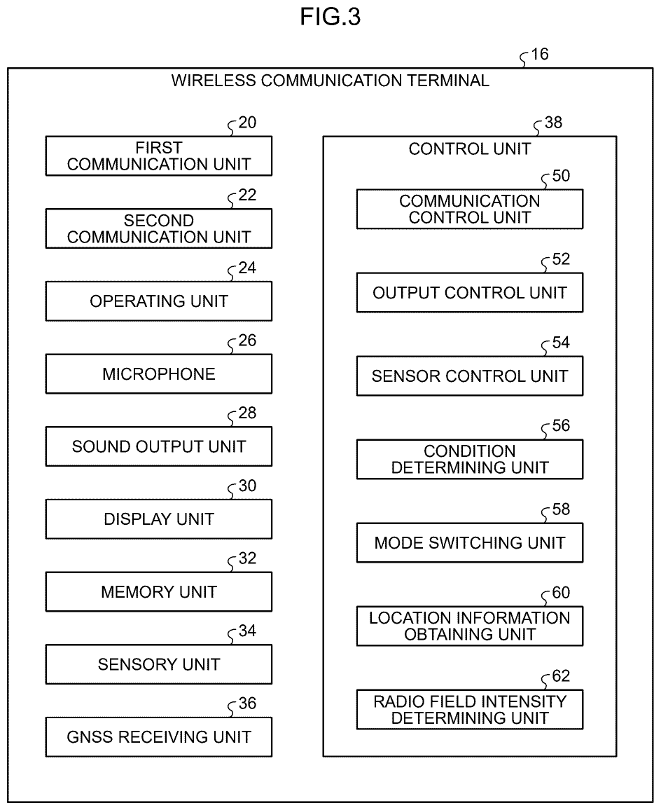

Explained below with reference to FIG. 3 is an exemplary configuration of the wireless communication terminal according to the first embodiment. FIG. 3 is a block diagram illustrating an exemplary configuration of the wireless communication terminal according to the first embodiment.

As illustrated in FIG. 3, the wireless communication terminal 16 includes a first communication unit 20, a second communication unit 22, an operating unit 24, a microphone 26, a sound output unit 28, a display unit 30, a memory unit 32, a sensor unit 34, a GNSS receiving unit 36 (GNSS stands for Global Navigation Satellite System), and a control unit 38. The wireless communication terminal 16 is, for example, a commercial wireless device. However, that is not the only possible case. Alternatively, for example, the wireless communication terminal 16 can be a smartphone. Still alternatively, for example, the wireless communication terminal 16 can be a combination of a commercial wireless device and a smartphone.

The first communication unit 20 performs communication with the base station device 14 or the other wireless communication terminals 16 by sending radio frequency (RF) signals. The communication method implemented by the first communication unit 20 is called the first wireless communication method. Examples of the first communication method include digital business radios such as APCO-P25 (Association of Public safety Communications Officials international Project 25) and NXDN (registered trademark). For example, the first wireless communication method can be the wireless communication performed using a mobile telephone network.

The second communication unit 22 perform communication with the other wireless communication terminals 16 by sending near field communication signals. The communication method implemented by the second communication unit 22 is called the second wireless communication method. Examples of the second wireless communication method include, but are not limited to, Wi-Fi (registered trademark) and Bluetooth (registered trademark).

In addition to including the first communication unit 20 and the second communication unit 22, the wireless communication terminal 16 can also include, for example, a USB communication unit configured using a USB port (USB stands for Universal Serial Bus).

The operating unit 24 receives various input operations with respect to the corresponding wireless communication terminal 16. The operating unit 24 outputs, to the control unit 38, an input signal corresponding to a received input operation. The operating unit 24 includes, for example, a touch-sensitive panel, buttons, switches, and a PTT button (PTT stands for Push to Talk).

The microphone 26 detects the sounds generated around the corresponding wireless communication terminal 16. For example, the microphone 26 detects the voice of the user of the wireless communication terminal 16. Then, for example, the microphone 26 outputs, to the control unit 38, a voice signal corresponding to the detected voice.

The sound output unit 28 outputs various sounds. For example, the sound output unit 28 outputs the voice of the user of another wireless communication terminal 16. Moreover, for example, when the wireless communication terminal 16 switches the communication mode to the emergency mode, the sound output unit 28 outputs an alarm. The sound output unit 28 is a speaker.

The display unit 30 displays various videos. For example, the display unit 30 is a display such as a liquid crystal display (LCD) or an organic electro-luminescence (EL) display.

The memory unit 32 stores therein a variety of information. The memory unit 32 stores therein the operation details of the control unit 38 and information such as computer programs. For example, the memory unit 32 includes at least either a main memory, such as a random access memory (RAM) or a read only memory (ROM), or an external storage device such as a hard disk drive (HDD).

Moreover, the memory unit 32 stores therein a variety of application software.

The sensor unit 34 detects the condition of the user of the corresponding wireless communication terminal 16. The sensor unit 34 detects that the user of the corresponding wireless communication terminal 16 is facing an emergency situation. For example, the sensor unit 34 includes a tilt sensor that detects the angle of the user (i.e., the wireless communication terminal 16) with respect to the ground surface. When it is detected that the angle of the user with respect to the ground surface has become equal to 0°, the tilt sensor detects that the user has collapsed on the ground. Moreover, for example, the sensor unit 34 includes an acceleration sensor for detecting the acceleration. When the acceleration equal to or greater than a predetermined level is detected, the acceleration sensor detects that the user has collapsed on the group. The sensor unit 34 either can include only one type of sensor, or can include a plurality of types of sensors.

The GNSS receiving unit 36 is configured using a GNSS receiver that receives GNSS signals from a GNSS satellite. The GNSS receiving unit 36 outputs the received GNSS signals to a location information obtaining unit 60 of the control unit 38.

The control unit 38 controls the constituent elements of the wireless communication terminal 16. For example, the control unit 38 is implemented using an information processing device such as a central processing unit (CPU) or a micro processing unit (MPU), and using a storage device such as a RAM or a RAM. Alternatively, for example, the control unit 38 can be implemented using an integrated circuit such as an application specific integrated circuit (ASIC) or a field programmable gate array (FPGA). Still alternatively, the control unit 38 can be implemented using a combination of hardware and software.

The control unit 38 includes a communication control unit 50, an output control unit 52, a sensor control unit 54, a condition determining unit 56, a mode switching unit 58, the location information obtaining unit 60, and a radio field intensity determining unit 62.

The communication control unit 50 controls the first communication unit 20 and the second communication unit 22. For example, the communication control unit 50 controls the first communication unit 20 to perform first-type wireless communication with the base station device 14 or with another wireless communication terminal 16 according to the first wireless communication method. Moreover, for example, the communication control unit 50 controls the first communication unit 20 to perform the wireless transmission operation and a first standby operation in a repeated manner. The first standby operation implies, for example, a standby operation for waiting for the reception of RF signals from the other wireless communication terminal 16. Furthermore, for example, the communication control unit 50 controls the second communication unit 22 to perform second-type wireless communication with the other wireless communication terminal 16 according to the second wireless communication method. Moreover, for example, the communication control unit 50 controls the second communication unit 22 to perform a second standby operation. The second standby operation implies a standby operation for waiting for the reception of near field communication signals from the other wireless communication terminal 16.

The output control unit 52 controls the sound output unit 28 and the display unit 30. For example, the output control unit 52 controls the sound output unit 28 to output various sounds. Moreover, for example, the output control unit 52 controls the display unit 30 to display various videos.

The sensor control unit 54 controls the sensor unit 34. The sensor control unit 54 controls the sensor unit 34 to detect the condition of the user of the corresponding wireless communication terminal 16. For example, the sensor control unit 54 controls the sensor unit 34 to detect whether or not the user of the corresponding wireless communication terminal 16 is facing an emergency situation. Then, from the sensor unit 34, the sensor control unit 54 obtains sensor information indicating the detection result about the condition of the user.

The condition determining unit 56 determines the condition of the user of the corresponding wireless communication terminal 16. Herein, based on the information obtained by the sensor control unit 54 from the sensor unit 34, the condition determining unit 56 determines the condition of the user of the corresponding wireless communication terminal 16. For example, the condition determining unit 56 determines whether or not the user of the corresponding wireless communication terminal 16 is facing an emergency situation that requires help.

The mode switching unit 58 switches the communication mode between the normal communication mode and the emergency mode. When it is determined that the user of the corresponding wireless communication terminal 16 is facing an emergency situation, the mode switching unit 58 switches the communication mode from the normal communication mode to the emergency mode.

The location information obtaining unit 60 obtains the current location information of the corresponding wireless communication terminal 16. Herein, based on the GNSS signals received by the GNSS receiving unit 36, the location information obtaining unit 60 obtains the current location information of the corresponding wireless communication terminal 16.

Moreover, the location information obtaining unit 60 obtains the current location information of the other wireless communication terminals 16. Herein, based on the GNSS signals that are included in the RF signals received from the other wireless communication terminals 16, the location information obtaining unit 60 obtains the current location information of the other wireless communication terminals 16.

The radio field intensity determining unit 62 determines the received radio field intensity of the RF signals received by the first communication unit 20 from the other wireless communication terminal 16 according to the first wireless communication method. For example, the radio field intensity determining unit 62 determines the RSSI value (RSSI stands for Received Signal Strength Indicator) of the RF signals received from the other wireless communication terminal 16.

### Communication Establishment Operation

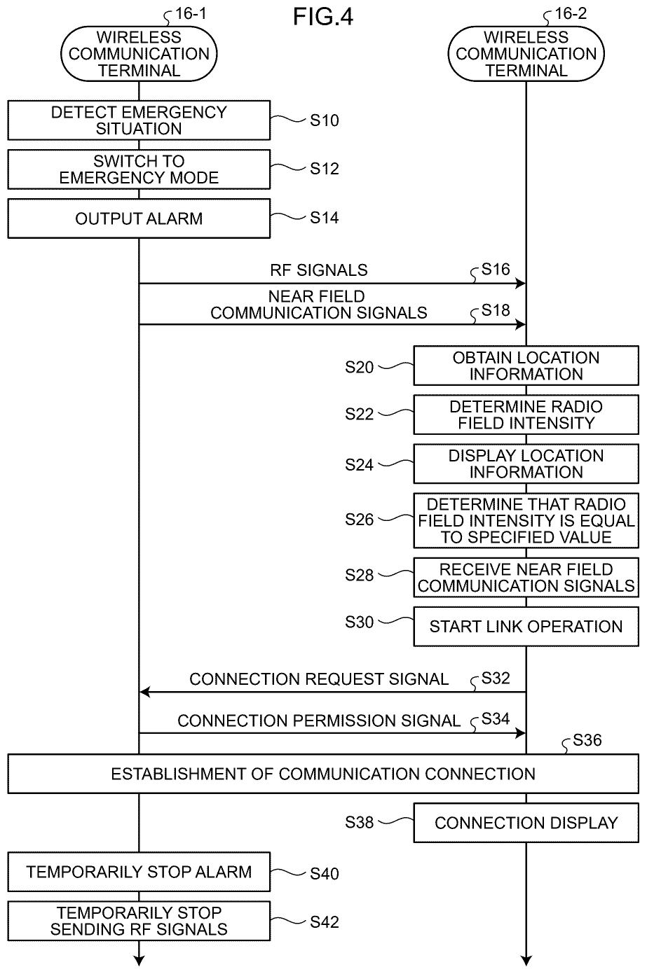

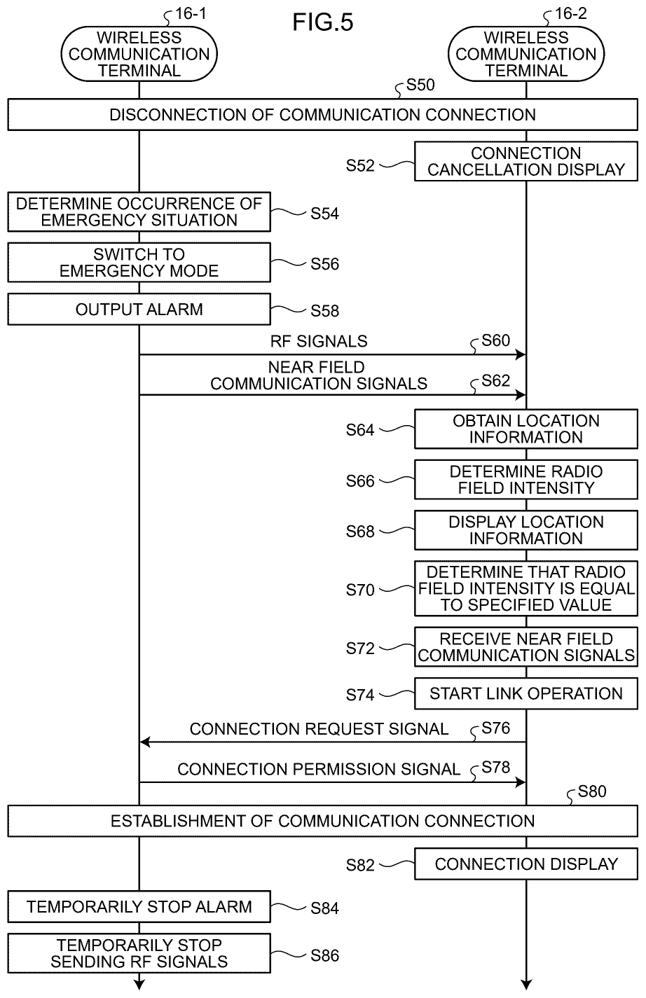

Explained below with reference to FIG. 4 is a communication establishment operation meant for establishing communication between the wireless communication terminals according to the first embodiment. FIG. 4 is a sequence diagram illustrating the flow of the communication establishment operation performed to establish communication between the wireless communication terminals according to the first embodiment.

In the example illustrated in FIG. 4, as illustrated in FIG. 2, it is assumed that the wireless communication terminal 16-1 is used by the user U1 who gets the help, and that the wireless communication terminal 16-2 is used by the user U2 who heads off to help out. The operations illustrated in FIG. 4 are the operations performed between the wireless communication terminals 16-1 and 16-2 when the user of the wireless communication terminal 16-1 faces an emergency situation and the user U2 of the wireless communication terminal 16-2 heads off to help out to the user U1 of the wireless communication terminal 16-1.

The wireless communication terminal 16-1 detects that the user U1 thereof is facing an emergency situation (Step S10). In the first embodiment, it is assumed that each of the wireless communication terminals 16-1 and 16-2 stores therein terminal information that contains the ID and the terminal name of the wireless communication terminal representing the communication partner. If the terminal information is not stored in the wireless communication terminals 16-1 and 16-2, a step for exchanging the terminal information of the wireless communication terminals 16-1 and 16-2 can be included before Step S10. Moreover, a step can also be included for identifying the terminal information of the wireless communication terminal 16-1 from terminal identification information included in the emergency information.

When an emergency situation of the user U1 of the wireless communication terminal 16-1 is detected, the wireless communication terminal 16-1 switches the communication mode from the normal communication mode to the emergency mode (Step S12). The wireless communication terminal 16-1 outputs an alarm sound from the sound output unit 28 as a notification of the location (Step S14). For example, the wireless communication terminal 16-1 outputs an alarm sound that is audible within a predetermined range centered around the wireless communication terminal 16-1.

The wireless communication terminal 16-1 sends RF signals, which indicate a call for help, to the wireless communication terminal 16-2 according to the first wireless communication method using the first communication unit 20 (Step S16). For example, the wireless communication terminal 16-1 includes the emergency information, which indicates that the user U1 of the wireless communication terminal 16-1 is facing an emergency situation, in the RF signal, and sends the RF signals to the wireless communication terminal 16-2. The emergency information can contain: the information indicating that the user U1 of the wireless communication terminal 16-1 is facing an emergency situation; the current location information (GNSS signals) of the wireless communication terminal 16-1; and the terminal information enabling identification of the wireless communication terminal 16-1. Then, the wireless communication terminal 16-1 sends near field communication signals to the wireless communication terminal 16-2 according to the second wireless communication method using the second communication unit 22 (Step S18). While the communication mode is switched to the emergency mode, the wireless communication terminal 16-1 performs the operation at Step S16 and the operation at Step S18 in a repeated manner at predetermined intervals. For example, the predetermined intervals are equal to a few seconds. However, they can be set in an arbitrary manner.

Herein, it serves the purpose if the emergency information contains, as the terminal information, the terminal identification information that enables identification of the terminal to which the emergency information is to be notified. Moreover, it serves the purpose if the wireless communication terminal that attempts to establish a connection according to the second wireless communication method with the terminal that notified the emergency information, that is, the wireless communication terminal representing the communication partner of the terminal that notified the emergency information uses the terminal identification information, which is included in the emergency information, at the time of identifying the connection destination. For example, the wireless communication terminal 16-1 includes the emergency information, which indicates that the user U1 of the wireless communication terminal 16-1 is facing an emergency situation, in the RF signals, and sends the RF signals to the wireless communication terminal 16-2. In the emergency information, the terminal identification information of the wireless communication terminal 16-1 is included. Moreover, the wireless communication terminal 16-1 sends near field communication signals to the wireless communication terminal 16-2 according to the second wireless communication method using the second communication unit 22. When near field communication signals are received according to the second wireless communication method using the second communication unit 22, if the terminal identification information can be obtained from the emergency signals received according to the first wireless communication method using the first communication unit 20; the wireless communication terminal 16-2 can identify, based on the terminal identification information, the near field communication signals received according to the second wireless communication method and, when it is determined that the near field communication signals are sent from the wireless communication terminal 16-1, can establish a connection.

Based on the RF signals received from the wireless communication terminal 16-1, the wireless communication terminal 16-2 obtains the location information of the wireless communication terminal 16-1 (Step S20). For example, based on the GNSS signals included in the RF signals, the wireless communication terminal 16-2 obtains the location information of the wireless communication terminal 16-1. Then, the wireless communication terminal 16-2 determines the radio field intensity of the RF signals received from the wireless communication terminal 16-1 (Step S22).

The wireless communication terminal 16-2 displays the location information, which indicates the current location of the wireless communication terminal 16-1, in the display unit 30 (Step S24). For example, the wireless communication terminal 16-2 displays map information, which indicates the current location of the wireless communication terminal 16-1, in the display unit 30. The user U2 of the wireless communication terminal 16-2 can check the display unit 30 for the location information of the wireless communication terminal 16-1, and can head off to help the user U1 of the wireless communication terminal 16-1.

The wireless communication terminal 16-2 determines that the radio field intensity of the RF signals has become equal to a specified value (Step S26). The specified value of the radio field intensity of the RF signals implies the value at the time when the distance between the wireless communication terminals 16-1 and 16-2 becomes equal to or shorter than a predetermined distance. That is, when the user U2 of the wireless communication terminal 16-2 has moved within a predetermined distance to the user U1 of the wireless communication terminal 16-1, the wireless communication terminal 16-2 determines that radio field intensity of the RF signals has become equal to the specified value. The predetermined distance between the wireless communication terminals 16-1 and 16-2 can be set in an arbitrary manner. For example, the predetermined distance between the wireless communication terminals 16-1 and 16-2 can be set to a distance at which near field communication can be performed between the wireless communication terminals 16-1 and 16-2.

The wireless communication terminal 16-2 receives near field communication signals from the wireless communication terminal 16-1 according to the second wireless communication method using the second communication unit 22 (Step S28). Upon receiving near field communication signals from the wireless communication terminal 16-1, the wireless communication terminal 16-2 starts a link operation for establishing a connection with the wireless communication terminal 16-1 (Step S30).

The wireless communication terminal 16-2 sends a connection request signal, which indicates a request for establishing a connection with the wireless communication terminal 16-1, to the wireless communication terminal 16-1 according to the second wireless communication method using the second communication unit 22 (Step S32). Then, the wireless communication terminal 16-1 sends a connection permission signal, which indicates the permission for establishing a connection with the wireless communication terminal 16-2, to the wireless communication terminal 16-2 according to the second wireless communication method using the second communication unit 22 (Step S34). Thus, when the wireless communication terminal 16-2 sends a connection request signal to the wireless communication terminal 16-1 and when the wireless communication terminal 16-1 sends a connection permission signal, which is an acknowledgment signal as a permission to establish a connection, to the wireless communication terminal 16-2 in response to receiving the connection request signal; communication is established between the wireless communication terminals 16-1 and 16-2 according to the second wireless communication method using the second communication unit 22 (Step S36).

At Step S36, the wireless communication terminals 16-1 and 16-2 can also communicate the identification information to each other. After the communication with the wireless communication terminal 16-1 is established, the wireless communication terminal 16-2 can periodically send help information, which indicates that the help is on the way, to the wireless communication terminal 16-1. For example, the help information can contain the identification information enabling identification of the user U2 of the wireless communication terminal 16-2 and can contain the current location information of the wireless communication terminal 16-2. However, the help information is not limited to the information mentioned above. Upon receiving the help information, the wireless communication terminal 16-1 displays it in the display unit 30. Thus, by checking the help information, the user U1 of the wireless communication terminal 16-1 becomes able to understand that the user U2 of the wireless communication terminal 16-2 is on the way to help out and to know the current location of the wireless communication terminal 16-1.

The wireless communication terminal 16-2 displays a connection display in the display unit 30 (Step S38). More particularly, for example, the wireless communication terminal 16-2 displays a message such as “Bluetooth signal link is established. Approaching the wireless communication terminal 16-1.” in the display unit 30. Thus, by checking the connection display, the user U2 of the wireless communication terminal 16-2 becomes able to know that the wireless communication terminal 16-1 is now close.

Then, the wireless communication terminal 16-1 temporarily stops outputting the alarm (Step S40). Moreover, the wireless communication terminal 16-1 temporarily suspends the wireless transmission operation. Herein, temporarily stopping the wireless transmission operation implies temporarily stopping the continuous transmission of RF signals according to the first wireless communication method (Step S42). That is, when communication is established with the wireless communication terminal 16-2 according to the second wireless communication method using the second communication unit 22, the wireless communication terminal 16-1 temporarily stops the continuous transmission of RF signals. As a result, it becomes possible to prevent a situation in which the communication band remains occupied due to the repeated transmission of RF signals from the wireless communication terminal 16-1.

### Communication Establishment Restoration Operation

Explained below with reference to FIG. 5 is a resumption operation meant for resuming the continuous transmission according to the first wireless communication method in a wireless communication terminal according to the first embodiment, and a communication establishment restoration operation meant for establishing communication between the wireless communication terminals. FIG. 5 is a sequence diagram illustrating the flow of the communication establishment restoration operation for restoring the communication between the wireless communication terminals according to the first embodiment.

The operations illustrated in FIG. 5 indicate: the resumption operation in which, after communication is established between the wireless communication terminals 16-1 and 16-2, if the communication is disconnected, the continuous transmission of RF signals from the wireless communication terminal 16-1 is resumed according to the first wireless communication method; and the operation for restoring the communication with the wireless communication terminal 16-2. The cases in which the communication gets disconnected include: the case in which the external communication environment deteriorates and the communication becomes unstable thereby resulting in disconnection; the case in which the distance between the terminals becomes too large and the communication connection cannot be maintained anymore thereby resulting in disconnection; the case in which the user operation of a terminal results in disconnection; and the case in which either the battery runs out or malfunctioning in the terminal results in the inability of the terminal to maintain the communication connection, thereby leading to disconnection.

The communication connection established between the wireless communication terminals 16-1 and 16-2 according to the second wireless communication method using the second communication unit 22 is disconnected (Step S50). For example, when the user U2 of the wireless communication terminal 16-2 moves away from the wireless communication terminal 16-1, the communication connection between the wireless communication terminals 16-1 and 16-2 is disconnected.

The wireless communication terminal 16-2 displays a connection cancellation display in the display unit 30 (Step S52). More particularly, the wireless communication terminal 16-2 displays a message such as “Bluetooth signal link is deactivated. Have moved away from the wireless communication terminal 16-1.” in the display unit 30. Thus, by checking the connection cancellation display, the user U2 of the wireless communication terminal 16-2 becomes able to know that the communication between the wireless communication terminals 16-1 and 16-2 is disconnected.

The wireless communication terminal 16-1 determines that the user U1 thereof is facing an emergency situation (Step S54). That is, when the once-established communication between the wireless communication terminals 16-1 and 16-2 is disconnected, the wireless communication terminal 16-1 determines that the emergency situation faced by the user U1 thereof is still ongoing. Meanwhile, from the state in which the continuous transmission in the emergency mode is temporarily stopped, if the communication connection according to the second wireless communication method is disconnected at Step S50, it is possible to skip Step S54 at which the determination about the emergency situation is performed.

The operations from Step S56 to Step S86 are identical to the operations from Step S12 to Step S42 illustrated in FIG. 4. Hence, that explanation is not given again. That is, when the once-established communication between the wireless communication terminals 16-1 and 16-2 is disconnected, the communication establishment operation is again performed so as to reestablish the communication between the wireless communication terminals 16-1 and 16-2. Herein, it serves the purpose if the operation of switching the communication mode to the emergency mode as performed at S56 implies resuming the continuous transmission that was temporarily stopped and restoring the original emergency mode.

### Communication Establishment End Operation

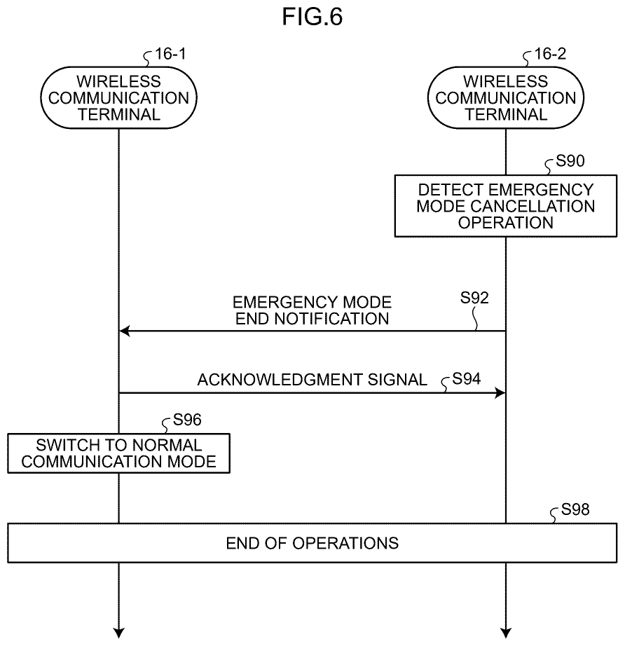

Explained below with reference to FIG. 6 is a communication establishment end operation meant for ending the communication established between the wireless communication terminals according to the first embodiment. FIG. 6 is a sequence diagram illustrating the flow of the communication establishment end operation for ending the communication established between the wireless communication terminals according to the first embodiment.

The operations illustrated in FIG. 6 are performed when the transmission in the emergency mode is no more required, such as in the case in which, when the communication connection is already established between the wireless communication terminal 16-1 of the user U1 and the wireless communication terminal 16-2 of the user U2 according to the second wireless communication method using the second communication unit 22 and when the wireless communication terminal 16-1 has temporarily stopped the wireless transmission operation, the user U2 who had headed off to help out either has found the user U1 of the wireless communication terminal 16-1 or has actually started helping.

The wireless communication terminal 16-2 detects an emergency mode cancellation operation (Step S90). More particularly, for example, the wireless communication terminal 16-2 detects the emergency mode cancellation operation that is input using the operating unit 24 by the user U2 of the wireless communication terminal 16-2 after finding the user U1 of the wireless communication terminal 16-1.

The wireless communication terminal 16-2 sends an emergency mode end notification for ending the emergency mode to the wireless communication terminal 16-1 according to the second wireless communication method using the second communication unit 22 (Step S92).

Upon receiving the emergency mode end notification from the wireless communication terminal 16-2, the wireless communication terminal 16-1 sends an acknowledgment signal (Ack) to the wireless communication terminal 16-2 according to the second wireless communication method using the second communication unit 22 (Step S94). Then, the wireless communication terminal 16-1 switches the communication mode from the emergency mode to the normal communication mode (Step S96).

Thus, the wireless communication terminals 16-1 and 16-2 end the communication establishment operation (Step S98).

### Operation Details of Wireless Communication Terminal

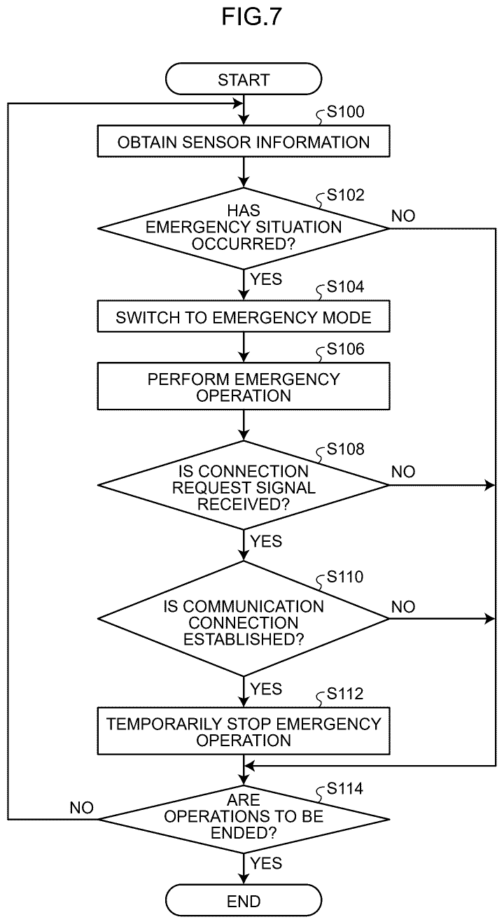

Explained below with reference to FIG. 7 are the operation details of the wireless communication terminal according to the first embodiment. FIG. 7 is a flowchart for explaining the operation details of the wireless communication terminal according to the first embodiment.

The sensor control unit 54 obtains the sensor information (Step S100). More particularly, the sensor control unit 54 obtains, from the sensor unit 34, the sensor information indicating the condition of the user of the corresponding wireless communication terminal 16 as detected by the sensor unit 34. Then, the system control proceeds to Step S102.

Based on the sensor information obtained by the sensor control unit 54, the condition determining unit 56 determines whether or not the user of the corresponding wireless communication terminal 16 is facing an emergency situation (Step S102). When it is determined that the user of the corresponding wireless communication terminal 16 is facing an emergency situation (Yes at Step S102), the system control proceeds to Step S104. On the other hand, when it is not determined that the user of the corresponding wireless communication terminal 16 is facing an emergency situation (No at Step S102), the system control proceeds to Step S114.

When the result of determination at Step S102 is affirmative, the mode switching unit 58 switches the communication mode of the wireless communication terminal 16 from the normal communication mode to the emergency mode (Step S104). Then, the system control proceeds to Step S106.

The communication control unit 50 controls the first communication unit 20 and the second communication unit 22, and ensures that the emergency operation is performed (Step S106). More particularly, the communication control unit 50 controls the first communication unit 20 to perform the RF signal transmission operation and the first standby operation in a repeated manner. Moreover, the communication control unit 50 controls the second communication unit 22 to perform the second standby operation in a repeated manner. Then, the system control proceeds to Step S108.

The communication control unit 50 determines whether or not a connection request signal is received (Step S108). More particularly, according to the result of the second standby operation performed by the second communication unit 22, the communication control unit 50 determines whether or not a connection request signal is received from the other wireless communication terminal 16. When it is determined that a connection request signal is received (Yes at Step S108), the system control proceeds to Step S110. On the other hand, when it is not determined that a connection request signal is received (No at Step S108), the system control proceeds to Step S114.

When the result of determination at Step S108 is affirmative, the communication control unit 50 determines whether or not a communication connection is established (Step S110). More particularly, the communication control unit 50 determines whether or not communication with the other wireless communication terminal 16 is established using the second communication unit 22. When it is determined that communication with the other wireless communication terminal 16 is established (Yes at Step S110), the system control proceeds to Step S112. On the other hand, when it is not determined that communication with the other wireless communication terminal 16 is established (No at Step S110), the system control proceeds to Step S114.

When the result of determination at Step S110 is affirmative, the communication control unit 50 temporarily stops the emergency operation (Step S112). Then, the system control proceeds to Step S114.

The control unit 38 determines whether or not to end the operations (Step S114). More particularly, when the user of the concerned wireless communication terminal is helped out, the control unit 38 determines to end the operations. Moreover, when an emergency mode end notification is received from the other wireless communication terminal 16, the control unit 38 determines to end the operations. When it is determined to end the operations (Yes at Step S114), the operations illustrated in FIG. 7 are ended. On the other hand, when it is not determined to end the operations (No at Step S114), the system control returns to Step S100.

As explained above, in the first embodiment, when a communication connection between the wireless communication terminal of the user waiting for help and the wireless communication terminal of the user heading off to help out is established according to the second wireless communication method, the communication according to the first wireless communication method in the wireless communication terminal of the user waiting for help is temporarily stopped. As a result, according to the first embodiment, it becomes possible to prevent a situation in which the communication band remains occupied during the emergency mode, and to appropriately help out the user who is facing an emergency situation.

### Second Embodiment

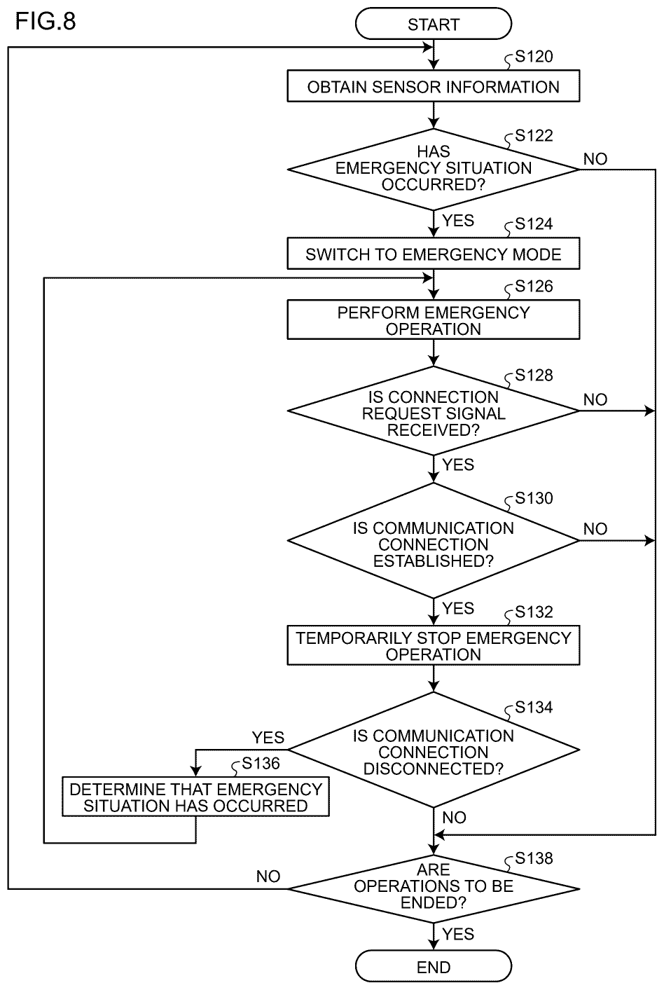

Explained below with reference to FIG. 8 are the operation details of the wireless communication terminal according to a second embodiment. FIG. 8 is a flowchart for explaining the operation details of the wireless communication terminal according to the second embodiment.

The operations performed from Step S120 to Step S132 are identical to the operations performed from Step S100 to Step S112 illustrated in FIG. 7. Hence, that explanation is not given again.

The communication control unit 50 determines whether or not the communication connection is disconnected (Step S134). More particularly, the communication control unit 50 determines whether or not the communication established with the other wireless communication terminal 16 according to the second wireless communication method using the second communication unit 22 is disconnected (Step S134). When it is determined that the communication connection is disconnected (Yes at Step S134), the system control proceeds to Step S136. On the other hand, when it is not determined that the communication connection is disconnected (No at Step S134), the system control proceeds to Step S138.

When the result of determination at Step S134 is affirmative, the condition determining unit 56 determines that the user of the corresponding wireless communication terminal 16 is facing an emergency situation (Step S136). Then, the system control returns to Step S126.

The operation performed at Step S138 is identical to the operation performed at Step S114 illustrated in FIG. 7. Hence, that explanation is not given again.

As explained above, in the second embodiment, after a communication connection between the wireless communication terminal of the user waiting for help and the wireless communication terminal of the user heading off to help out is established according to the second wireless communication method, even if the communication connection is disconnected, it becomes possible to reestablish the communication connection. As a result, according to the second embodiment, it becomes possible to appropriately help out the user who is facing an emergency situation.

### Third Embodiment

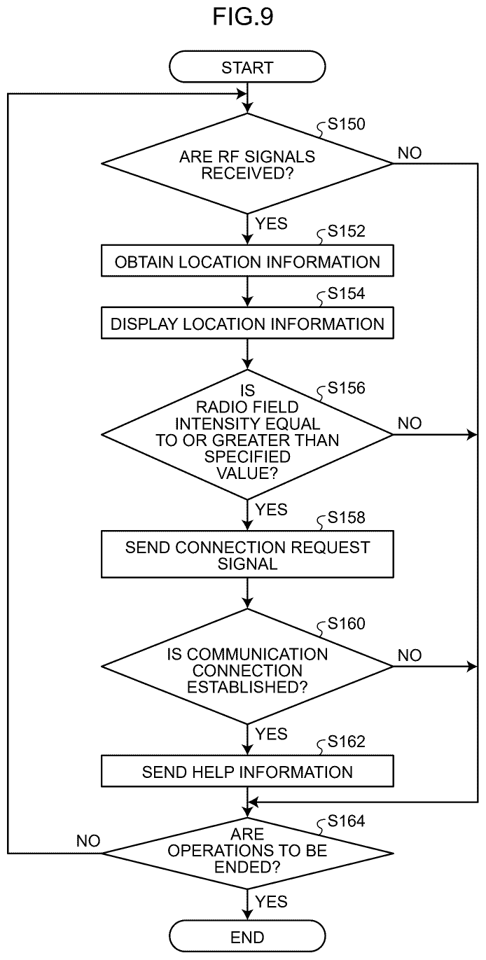

Explained below with reference to FIG. 9 are the operation details of the wireless communication terminal according to a third embodiment. FIG. 9 is a flowchart for explaining the operation details of the wireless communication terminal according to the third embodiment.

The operations illustrated in FIG. 9 are performed in the wireless communication terminal of the user who heads off to help out to the user who is facing an emergency situation.

The communication control unit 50 determines whether or not RF signals, which indicate a call for help, are received from the other wireless communication terminal 16 (Step S150). More particularly, the communication control unit 50 determines whether or not RF signals, which indicate a call for help, are received from the other wireless communication terminal 16 according to the first wireless communication method using the first communication unit 20. When it is determined that RF signals are received (Yes at Step S150), the system control proceeds to Step S152. On the other hand, when it is not determined that RF signals are received (No at Step S150), the system control proceeds to Step S164.

When the result of determination at Step S150 is affirmative, the location information obtaining unit 60 obtains the location information indicating the current location of the other wireless communication terminal 16 (Step S152). More particularly, based on the GNSS signals included in the RF signals, the location information obtaining unit 60 obtains the location information indicating the current location of the other wireless communication terminal 16. Then, the system control proceeds to Step S154.

The output control unit 52 displays the location information, which indicates the current location of the other wireless communication terminal 16, in the display unit 30 (Step S154). Then, the system control proceeds to Step S156.

The radio field intensity determining unit 62 determines whether or not the radio field intensity of the RF signals, which are received from the other wireless communication terminal 16, has become equal to or greater than the specified value (Step S156). When it is determined that the radio field intensity of the RF signals has become equal to or greater than the specified value (Yes at Step S156), the system control proceeds to Step S158. On the other hand, when it is not determined that the radio field intensity of the RF signals has become equal to or greater than the specified value (No at Step S156), the system control proceeds to Step S164.

When the result of determination at Step S156 is affirmative, the communication control unit 50 sends a connection request signal to the other wireless communication terminal 16 (Step S158). More particularly, the communication control unit 50 sends a connection request signal to the other wireless communication terminal 16 according to the second wireless communication method using the second communication unit 22. Then, the system control proceeds to Step S160.

The communication control unit 50 determines whether or not a communication connection is established between the concerned wireless communication terminal 16 and the other wireless communication terminal 16 (Step S160). More particularly, the communication control unit 50 determines whether or not a communication connection is established between the concerned wireless communication terminal 16 and the other wireless communication terminal 16 according to the second wireless communication method using the second communication unit 22. When it is determined that a communication connection is established (Yes at Step S160), the system control proceeds to Step S162. On the other hand, when it is not determined that a communication connection is established (No at Step S160), the system control proceeds to Step S164.

When the result of determination at Step S160 is affirmative, the communication control unit 50 sends the help information to the other wireless communication terminal 16 (Step S162). Then, the system control proceeds to Step S164.

The control unit 38 determines whether or not to end the operations (Step S164). More particularly, for example, when the operating unit 24 of the concerned wireless communication terminal 16 receives an emergency mode end operation for cancelling the emergency mode of the other wireless communication terminal 16, the control unit 38 determines to end the operations. When it is determined to end the operations (Yes at Step S164), the operations illustrated in FIG. 9 are ended. On the other hand, when it is not determined to end the operations (No at Step S164), the system control returns to Step S150.

As explained above, in the third embodiment, to the wireless communication terminal of the user who is facing an emergency situation and is waiting for help, the help information is sent from the wireless communication terminal of the user who is heading off to help out. As a result, according to the third embodiment, the user who is facing an emergency situation and is waiting for help can be made aware of the fact that another user is coming to help out, and hence can be assured with a sense of security.

### Fourth Embodiment

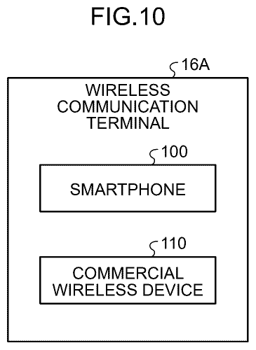

Explained below with reference to FIG. 10 is an exemplary configuration of a wireless communication terminal according to a fourth embodiment. FIG. 10 is a block diagram illustrating an exemplary configuration of the wireless communication terminal according to the fourth embodiment.

As illustrated in FIG. 10, a wireless communication terminal 16A includes a smartphone 100 and a commercial wireless device 110. The smartphone 100 and the commercial wireless device 110 are communicably connected to each other by a USB cable. Thus, according to the application concerned, a wireless communication terminal can include a plurality of wireless communication devices of different types.

When within the service area of the radio waves for mobile telephones, the user can talk with another user using the smartphone 100. While the smartphone 100 is in use for a call, the commercial wireless device 110 functions as a speaker-microphone. That is, the commercial wireless device 110 outputs the voice received from the other user. When the concerned user inputs the voice into the commercial wireless device 110 while pressing its PTT button, the voice signals from the smartphone 100 are sent.

When outside the range of radio waves for mobile telephones, the user performs communication using only the commercial wireless device 110.

From among the operations illustrated in FIGS. 4 to 6, the smartphone 100 performs the operations at Steps S24, S38, S52, S68, and S82. That is, from among the operations performed by the wireless communication terminal 16 illustrated in FIG. 3, the smartphone 100 performs the operations in which information is displayed in the display unit 30.

From among the operations illustrated in FIGS. 4 to 6, the commercial wireless device 110 performs the operations other than the operations at Steps S24, S38, S52, S68, and S82. That is, from among the operations performed by the wireless communication terminal 16 illustrated in FIG. 3, the commercial wireless device 110 performs the operations other than the operations in which information is displayed in the display unit 30.

As explained above, in the fourth embodiment, a wireless communication terminal is configured using a plurality of communication devices of different types. As a result, according to the fourth embodiment, it becomes possible to prevent a situation in which the communication band remains occupied during the emergency mode, and to appropriately help out the user who is facing an emergency situation.

The constituent elements of the device illustrated in the drawings are merely conceptual, and need not be physically configured as illustrated. The constituent elements, as a whole or in part, can be separated or integrated either functionally or physically based on various types of loads or use conditions. The configuration based on such separation/integration can be done in a dynamic manner.

According to the application concerned, it becomes possible to efficiently control the wireless transmission operation during the emergency mode, and to hold down interference and congestion of the communication band.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wireless communication terminal comprising:
a first communication unit that performs first-type wireless communication according to a first wireless communication method;
a second communication unit that performs second-type wireless communication according to a second wireless communication method which is different than the first wireless communication method; and
a control unit that controls the first communication unit and the second communication unit, wherein
in a state in which communication mode is switched from a normal communication mode to a predetermined communication mode in which the first communication unit performs continuous transmission according to the first wireless communication method, when the second communication unit receives a connection request signal and establishes a communication connection by sending an acknowledgment signal as a permission for establishing a connection, the control unit controls the first communication unit to temporarily stop continuous transmission performed according to the first wireless communication method.

2. The wireless communication terminal according to claim 1, wherein, in the first communication unit, in a state in which continuous transmission in the predetermined communication mode is temporarily stopped, when communication connection with the second communication unit is disconnected, the control unit controls the first communication unit to resume continuous transmission according to the first wireless communication method.

3. The wireless communication terminal according to claim 1, wherein, in a state in which the predetermined communication mode is set, the control unit performs control in such a way that a signal that is sent during continuous transmission according to the first communication method has terminal identification information included therein for use at time of connection establishment with the wireless communication terminal according to the second wireless communication method.

4. A communication method in which a first communication unit is controlled to perform first-type wireless communication according to a first wireless communication method and a second communication unit is controlled to perform second-type wireless communication according to a second wireless communication method that is different than the first wireless communication method, the communication method comprising:
performing control, by a control unit, that includes controlling the first communication unit to switch communication mode from a normal communication mode to a predetermined communication mode in which continuous transmission is performed according to the first wireless communication method;
receiving, by the second communication unit, that includes receiving a connection request signal;
performing control, by the control unit, that includes controlling the second communication unit to send an acknowledgment signal as a permission for establishing a connection in response to the received connection request signal and to establish a communication connection using the second communication unit; and
performing control, by the control unit, that, after establishment of the communication connection, includes controlling the first communication unit to temporarily stop continuous transmission performed according to the first wireless communication method.

5. A non-transitory computer-readable storage medium storing a program causing a computer to execute, having a computer readable medium including a computer program for causing a computer to perform an operation in which a first communication unit is controlled to perform first-type wireless communication according to a first wireless communication method and a second communication unit is controlled to perform second-type wireless communication according to a second wireless communication method that is different than the first wireless communication method, wherein the computer program, when executed by the computer, causes the computer to execute:
performing control, by a control unit, that includes controlling the first communication unit to switch communication mode from a normal communication mode to a predetermined communication mode in which continuous transmission is performed according to the first wireless communication method;
receiving, by the second communication unit, that includes receiving a connection request signal;
performing control, by the control unit, that includes controlling the second communication unit to send an acknowledgment signal as a permission for establishing a connection in response to the received connection request signal and to establish a communication connection using the second communication unit; and
performing control, by the control unit, that, after establishment of the communication connection, includes controlling the first communication unit to temporarily stop continuous transmission performed according to the first wireless communication method.
